(19) United States
(12) Patent Application Publication
(10) Pub. No.: US 2022/0332287 A1
(43) Pub. Date: Oct. 20, 2022

(54) METHOD AND DEVICE FOR THE EXTERNAL ELECTRICAL POWER SUPPLY OF UNLOCKING-RELATED DEVICES OF A VEHICLE

(71) Applicant: MERCEDES-BENZ GROUP AG, Stuttgart (DE)

(72) Inventor: David WIDDECKE, Holzgerlingen (DE)

(21) Appl. No.: 17/641,863

(22) PCT Filed: Aug. 18, 2020
(86) PCT No.: PCT/EP2020/073123

§ 371 Date: Mar. 10, 2022

(30) Foreign Application Priority Data
Sep. 11, 2019 (DE) 10 2019 006 415.1

(51) Int. Cl. B60R 25/40; B60R 25/24

(52) U.S. Cl. CPC B60R 25/403; B60R 25/246; B60R 25/406

(57) ABSTRACT

Keyless authentication of an authorized user of a vehicle in the event of an error function of an internal electrical power supply of unlocking-related devices of the vehicle is provided so that only one portion of the control units of the vehicle, in particular only unlocking-related devices of the vehicle, are supplied with electrical power via an external electrical power source, in order to carry out keyless authentication of the authorized user.

### BACKGROUND AND SUMMARY OF THE INVENTION

Exemplary embodiments of the invention relate to a method and a device for the external electrical power supply of unlocking-related devices of a vehicle in the event of an error function of an internal electrical power supply of these devices using an internal electrical power source arranged in the vehicle, in order to provide keyless authentication of an authorized user of the vehicle. Exemplary embodiments of the invention also relate to a vehicle having a device according to the invention for carrying out the method according to the invention.

DE 102 36 957 B4 relates to closing devices comprising a lockable and unlockable lock on a mobile part of the vehicle bodywork where a handle for opening the mobile part is also placed. Arranged in the handle are handle sensors, which respond when the access and operation control system is rendered operative, the latter consisting of an ID provider, an ID receiver, and communication units for the ID provider.

DE 10 2007 026 165 A1 relates to a switching device for the electrical connection of a plurality of consumers in a motor vehicle to at least one electrical power source, wherein the switching device has at least one switch driven by an electric motor, wherein the switch has a plurality of switch positions and, in the various switch positions, various consumers respectively can be connected to the at least one power source or disconnected from it individually, together or in prescribed groups.

DE 102 43 318 B4 relates to a drive authorization system for means of transport, having a vehicle-fixed recognition device for carrying out a communication with a mobile approval device checking the authorization for use and an ignition lock for an ignition key and a control device unit for activating ignition lock functions, such as starting up and switching off the engine, when the ignition key is placed into a corresponding position in the ignition lock.

DE 10 2018 212 407 B3 relates to an electronic door locking system of a motor vehicle, comprising at least one receiver for the transmit signals of an electronic key, at least one control device for the mechanical locking and unlocking of at least one motor vehicle door, at least one contact element accessible from outside the motor vehicle for connecting to an external voltage source and at least one switching element, wherein a control unit is provided for switching element in the motor vehicle which is connected to the contact element and to an onboard electrical system battery, wherein the control unit is formed such that, depending on the voltage situation at the contact element and the onboard electrical system battery, the switching element is switched into a first switch position or a second switch position, wherein, in the first switch position, the contact element is decoupled from the electrical onboard electrical system of the motor vehicle and, in the second switch position, at least the electrical onboard electrical system consumers required for the locking and unlocking are connected to the contact element and decoupled from the onboard electrical system battery.

DE 100 49 321 A1 relates to a device for externally feeding current into a motor vehicle, for the supplying of current to electrical consumers which are internally connected to an energy storage device of a motor vehicle onboard electrical system.

In order to allow the operation of consumers such as, in particular, electronic access authorization systems even if the onboard electrical system fails, for example as a result of a drained or defective energy storage device, it is proposed according to the invention that an inductive receiving device be arranged in the motor vehicle that is at least connected to a consumer in the motor vehicle and into which electrical current can be inductively coupled from outside.

US 2017/0089104 A1 relates to an electrical door release system and an electrical door release method.

In modern vehicles, keyless authentication of an authorized user is carried out when access to the vehicle is approved, access to the vehicle only being allowed if the keyless authentication of the authorized user was successful. For example, radio communication between the vehicle and a mobile identification provider carried by the authorized user is used here to allow convenient keyless authentication. Keyless authentication is therefore to be understood to mean that a mechanical and/or physically formed key is dispensed with.

In modern vehicles, not only is a mechanically and/or physically formed key dispensed with, but also mechanically and/or physically formed emergency keys for emergency unlocking of the vehicle. In particular when shared services are offered, such as car sharing, key rights are provided digitally without any real contact between lessor and lessee, so no emergency key could be provided even if such a key existed.

A problem with keyless authentication is that vehicle-based unlocking-related devices have to be supplied with electrical power to allow keyless authentication. In the event of operational disruption and/or an error function of a vehicle battery of the vehicle or some other damage to an onboard electrical system of the vehicle, keyless authentication cannot take place since the vehicle-based unlocking-related devices are not supplied with electrical power in such a case. If such an error function of the vehicle occurs after the vehicle has been locked, the authorized user cannot access the vehicle. In cases were no mechanical and/or physical emergency key is present and/or provided, non-destructive access to the vehicle is no longer possible.

The problem underlying the present invention is to provide for a non-destructive unlocking of a vehicle in the event of an operational failure and/or error function of a vehicle battery of the vehicle or some other damage to an onboard electrical system of the vehicle, in particular a non-destructive unlocking of the vehicle, which allows keyless authentication even in emergency situations so that only an authorized user accesses the vehicle.

The present invention is based on the general idea that only one portion of the control units of the vehicle, in particular only unlocking-related devices of the vehicle, are supplied with electrical power via an external electrical power source, in order to carry out keyless authentication of the authorized user. Since only part of the control unit of the vehicle is supplied with electrical power, it is possible, for example, to use external mobile power sources having an electrical power storage capacity which can be provided, for example, through smartphone batteries and/or through USB power banks.

The method according to the invention for the external electrical power supply of unlocking-related devices of a vehicle in the event of an error function of an internal electrical power supply of these devices using an internal electrical power source arranged in the vehicle, in order to provide keyless authentication of an authorized user of the vehicle, provides for an external electrical power source to supply a protective circuit device with electrical power.

Internally can be understood to mean that a unit is arranged in the vehicle and is not accessible from outside when the vehicle is locked. Externally can be understood to mean that a unit is arranged outside the vehicle.

The internal electrical power supply of unlocking-related devices of the vehicle through the internal electrical power source arranged in the vehicle ensures that keyless authentication of an authorized user is made possible if the operating status of the vehicle is free of error functions. An internal electrical power source can be understood to mean an electrical power source arranged in the vehicle and that is not accessible from outside when the vehicle is locked. This electrical power source may, for example, be an electrical vehicle battery and/or an electrical vehicle accumulator.

Keyless authentication can be understood to mean authentication that dispenses with the use of a mechanical and/or physically formed key and authentication via digital data transmission, in particular radio digital data transmission, between a mobile identification provider which is located outside the vehicle and unlocking-related devices which are arranged in the vehicle.

The external electrical power source can be a mobile electrical power source which is characterized by the fact that it is separate from a stationary power supply network, in particular from a stationary voltage supply network.

The external electrical power source can be electrically connected via power supply connections, which are also formed to be accessible from outside if a vehicle is locked, so that the protective circuit device is supplied with electrical power. The power supply connections can form an electrical connection between the external electrical power source and the protective circuit device here.

The method also provides for the protective circuit device to transform the electrical power supplied from the external electrical power source so that unlocking-related devices of the vehicle can be operated non-destructively. It is possible hereby, for example, to prevent damage to vehicle components, in particular an onboard electrical system and/or unlocking-related devices, through improper use. Furthermore, it is also possible hereby to prevent deliberate attempts to cause damage (for example through electric shocks). All further electrical voltages and/or electrical currents that lie above a predefined operating voltage (working voltage) and/or a predefined operating current (working currents) can be prevented.

The method also provides for the protective circuit device to supply exclusively unlocking-related devices of the vehicle, in particular unlocking-related devices of the vehicle that are involved in keyless authentication of an authorized user of the vehicle, with electrical power in order to reduce the amount of external electrical power required. Since only part of the control unit of the vehicle is supplied with electrical power, it is possible, for example, to use external mobile power sources having an electrical power storage capacity, which can be provided, for example, through smartphone batteries and/or through USB power banks.

The unlocking-related devices of the vehicle may, for example, comprise an electrical ignition lock unit and/or a radio receiver unit and/or a door control device unit and/or an electrical door actuator unit and/or a signal detection device. The electrical ignition lock unit can be connected to the radio receiver unit and/or the door control device unit and/or the signal detection device so as to be able to communicate. The communicating connection can be formed via a bus system.

The unlocking-related devices of the vehicle involved in keyless authentication of an authorized user of the vehicle may, for example, be formed by the electrical ignition lock unit and the radio receiver unit. The electrical ignition lock unit can be connected to the radio receiver unit so as to be able to communicate. The communicating connection can be formed via a bus system.

As a result of a dedicated power supply to these vehicle components, only a fraction of the electrical power that would be needed to recharge the vehicle battery is needed by comparison. The external electrical power source can therefore be formed to be smaller than a vehicle battery in terms of its physical dimensions.

In order to achieve a further reduction in the amount of external power required, provision can be made for a two-stage and/or delayed power supply to the unlocking-related devices of the vehicle. Provision can be made here, for example, for the unlocking-related devices of the vehicle involved in keyless authentication of an authorized user of the vehicle to be supplied with electrical power first of all and the remaining unlocking-related devices of the vehicle, in particular the door control device unit and/or the electrical door actuator unit and/or the signal detection device, only after a positive authentication of the authorized user.

In an emergency, unlocking-related devices of the vehicle involved in keyless authentication of an authorized user of the vehicle can be supplied with electrical power via an electrical power source of a mobile identification provider. The mobile identification provider may, for example, be a smartphone or a transponder key.

The method also provides for keyless authentication of an authorized user of the vehicle to be provided by the unlocking-related devices of the vehicle after the unlocking-related devices of the vehicle have been supplied with electrical power. In particular, the keyless authentication of an authorized user of the vehicle can be provided through unlocking-related devices of the vehicle involved in keyless authentication of an authorized user of the vehicle.

The method also provides for the keyless authentication of an authorized user of the vehicle to be carried out by means of a mobile identification provider in an external power supply of the unlocking-related devices through the external electrical power source in the same way as keyless authentication of an authorized user of the vehicle in an internal power supply of the unlocking-related devices using an internal electrical power source arranged in the vehicle.

The authentication can be carried out by means of the mobile identification provider with the original operating elements of the identification provider. After successful authentication of an authorized user, a mechanical unlocking of the vehicle, in particular of a vehicle door, can be carried out.

The unlocking-related devices of the vehicle can carry out the following method steps here:

The electrical ignition lock unit can carry out the keyless authentication and gives the order to unlock only if a valid digital key has been detected outside the vehicle. For this purpose, the electrical ignition lock unit can send a request to the radio receiver unit asking whether the radio receiver unit has received a radio signal with a digital key. If the radio receiver unit has received a digital key, this can be transmitted to the electrical ignition lock unit for validation. If the electrical ignition lock unit identifies a valid digital key, it sends an order to the door control device unit requesting the electrical door actuator unit to unlock a door lock. The door control device unit controls the electrical door actuator unit such that a safety catch of the door lock is released via an electric motor of the electrical door actuator unit. Provision can also be made for the electrical ignition lock unit to transmit an order to the door control device unit only if it has identified a valid digital key and if it has received an actuation signal from the signal detection device. The signal detection device can be formed through a door handle device.

The keyless authentication therefore takes place in a regular manner that corresponds to the keyless authentication provided for in normal operation in which the vehicle has no operational failure and/or error function of the vehicle battery or no other damage to the onboard electrical system. This allows a non-destructive unlocking of the vehicle which also allows keyless authentication in emergency situations, this keyless authentication meeting predefined safety standards and only allowing an authorized user to access the vehicle.

After a vehicle has been unlocked, the external electrical power source can be separated from the vehicle.

In an advantageous refinement of the solution according to the invention, provision is made for the external electrical power source to be provided by a mobile identification provider for keyless authentication of the authorized user of the vehicle, and/or for the external electrical power source to be provided through a mobile electrical power storage device, in particular through a USB power bank, and/or for the external electrical power source to be able to be electrically connected to the protective circuit device via one or more power supply connections, in particular via at least one USB connection and/or via at least one terminal connection.

In an emergency, unlocking-related devices of the vehicle involved in keyless authentication of an authorized user of the vehicle can be supplied with electrical power via an electrical power source of a mobile identification provider. The mobile identification provider may, for example, be a smartphone or a transponder key.

If the amount of external electrical power provided by a mobile identification provider is not enough to supply electromechanical components, such as a door actuator unit of the vehicle for the electrical opening of a locking system, with enough electrical power, use can alternatively and/or additionally be made, for example, of a USB power bank as an external electrical power source. The USB power bank can be formed as a USB-C power bank.

The external electrical power source can be electrically connectable to the protective circuit device via one or more power supply connections. Provision can be made for at least one USB connection, in particular a USB-PD connection and/or a USB-C connection, and at least one bipolar terminal connection to be provided. Whilst the bipolar terminal connection has at least two current supply lines, the USB connection forms a communication line and a current supply line, only the communication line of the USB connection being specified below for the sake of clarity, but a communication line and a current supply line of the USB connection always being meant thereby. The USB connection can form a plug, in particular a female plug, into which the communication line and the current supply line of the USB connection flow.

The mobile identification provider, in particular a smartphone or a transponder key, can be connected to a communication line via a USB connection.

A USB power bank can be connected to a communication line via the USB connection.

A USB-C connection is particularly suitable so that the latter can transmit a high current strength as standard whilst at the same time requiring a physically smaller plug.

It is also possible for a plurality of terminals, in particular a plurality of USB-C power banks, to be electrically connected via a USB-C connection so that the authorized user can use their existing electronic terminals for the external electrical power supply.

In order to extend the range of possible connections, a terminal connection can also be provided. This can be used through the connection of a bipolar charger. Examples of such include a jump lead, a car charger or virtually any bipolar connection.

Depending on the accessory available, the authorized user can choose between a USB-C connection or a conventional terminal connection similar to a jump start support point. In order to feed in current, for example, a power bank can be connected to the USB-C connection or a jump lead can be clamped to the terminal connection.

In an advantageous refinement of the solution according to the invention, provision is made for the protective circuit device to provide high voltage protection, and/or for the protective circuit device to provide overvoltage protection, and/or for the protective circuit device to provide residual voltage peak protection, and/or for the protective circuit device to provide reverse polarity protection, and/or for the protective circuit device to transform the electrical power supplied from the external electrical power source so that unlocking-related devices of the vehicle are provided with an operating current of substantially 5 A and/or an operating voltage of substantially 15 V.

The high voltage protection of the protective circuit device can provide protection against high voltage above 350 V. The high voltage protection of the protective circuit device can provide protection against high voltage above 350 V in respect of the overvoltage protection and/or the residual voltage peak protection and/or the reverse polarity protection and/or unlocking-related devices of the vehicle.

The overvoltage protection of the protective circuit device can provide protection against high voltage above 26 V. The overvoltage protection of the protective circuit device can provide protection against high voltage above 26 V in respect of the residual voltage peak protection and/or the reverse polarity protection and/or unlocking-related devices of the vehicle.

The residual voltage peak protection of the protective circuit device can provide protection against residual voltage peaks, in particular voltage smoothing. The residual voltage peak protection of the protective circuit device can provide protection against residual voltage peaks in respect of the reverse polarity protection and/or unlocking-related devices of the vehicle.

The reverse polarity protection of the protective circuit device can facilitate operation since a user can connect to the positive or negative pole as desired.

The high voltage protection can be electrically connected to the external electrical power source on the input side and to the overvoltage protection on the output side. The overvoltage protection can be electrically connected to the high voltage protection on the input side and to the residual voltage peak protection on the output side. The residual voltage peak protection can be electrically connected to the overvoltage protection on the input side and to the reverse polarity protection on the output side. The reverse polarity protection can be electrically connected to the residual voltage peak protection on the input side and to the unlocking-related devices of the vehicle on the output side.

If the protective circuit device transforms the electrical power supplied from the external electrical power source so that unlocking-related devices of the vehicle are provided with an operating current of substantially 5 A and/or an operating voltage of substantially 15 V, then the unlocking-related devices of the vehicle can be supplied with precisely the electrical power that they would also receive via the onboard electrical system in the failure-free normal operation of the vehicle.

In an advantageous refinement of the solution according to the invention, provision is made for a mechanical unlocking of the vehicle, in particular of a vehicle door, to be carried out after a successful keyless authentication of an authorized user of the vehicle if an activation of a door by the authorized user of the vehicle is detected by a door handle device and/or if the external electrical power source is formed as a USB power bank and provides a sufficient amount of electrical power to carry out a mechanical unlocking of the vehicle.

The invention also relates to a device for the external electrical power supply of unlocking-related devices of a vehicle in the event of an error function of an internal electrical power supply of these devices using an internal electrical power source arranged in the vehicle, in order to provide keyless authentication of an authorized user of the vehicle. The device is formed, in particular, for carrying out the method described above.

The device comprises here a protective circuit device, which can be supplied with electrical power via an external electrical power source, wherein the protective circuit device is formed so that it transforms the electrical power supplied from the external electrical power source so that unlocking-related devices of the vehicle can be operated non-destructively.

The protective circuit device is electrically conductively connected to unlocking-related devices of the vehicle, in particular unlocking-related devices of the vehicle involved in keyless authentication of an authorized user of the vehicle, and exclusively supplies these with electrical power in order to reduce the amount of external electrical power required, wherein the unlocking-related devices of the vehicle are formed for the keyless authentication of an authorized user of the vehicle.

The external electrical power source can be a mobile electrical power source which is characterized by the fact that it is separate from a stationary power supply network, in particular from a stationary voltage supply network.

The external electrical power source can be electrically connected via power supply connections of the device that are also formed to be accessible from outside if a vehicle is locked, so that the protective circuit device is supplied with electrical power. The power supply connections can form an electrical connection between the external electrical power source and the protective circuit device here.

The protective circuit device transforms the electrical power supplied from the external electrical power source so that unlocking-related devices of the vehicle can be operated non-destructively. It is possible hereby, for example, to prevent damage to vehicle components, in particular an onboard electrical system and/or unlocking-related devices, through improper use. Furthermore, it is also possible hereby to prevent deliberate attempts to cause damage (for example through electric shocks). All further electrical voltages and/or electrical currents that lie above a predefined operating voltage (working voltage) and/or a predefined operating current (working currents) can be prevented.

The device can comprise unlocking-related devices of the vehicle, in particular unlocking-related devices of the vehicle involved in keyless authentication of an authorized user of the vehicle.

The unlocking-related devices of the vehicle may, for example, comprise an electrical ignition lock unit and/or a radio receiver unit and/or a door control device unit and/or an electrical door actuator unit and/or a signal detection device. The electrical ignition lock unit can be connected to the radio receiver unit and/or the door control device unit and/or the signal detection device so as to be able to communicate. The communicating connection can be formed via a bus system.

The unlocking-related devices of the vehicle involved in keyless authentication of an authorized user of the vehicle may, for example, be formed by the electrical ignition lock unit and the radio receiver unit. The electrical ignition lock unit can be connected to the radio receiver unit so as to be able to communicate. The communicating connection can be formed via a bus system.

As a result of a dedicated power supply to these vehicle components, only a fraction of the electrical power that would be needed to recharge the vehicle battery is needed by comparison. The external electrical power source can therefore be formed to be smaller than a vehicle battery in terms of its physical dimensions.

The devices of the vehicle can comprise the following units: An electrical ignition lock unit for the keyless authentication or validation of digital keys. A radio receiver unit for receiving radio signals and/or digital keys. A door control device unit for driving an electrical door actuator unit for unlocking a door lock. An electrical door actuator unit that can release a safety catch of the door lock via an electric motor. A signal detection device for detecting door activation gestures. The signal detection device can be formed through the door handle device. These units can be connected to one another via a bus system so as to be able to communicate.

The keyless authentication therefore takes place in a regular manner corresponding to the keyless authentication provided for in normal operation in which the vehicle has no operational failure and/or error function of the vehicle battery or no other damage to the onboard electrical system. This allows a non-destructive unlocking of the vehicle that also allows keyless authentication in emergency situations, this keyless authentication meeting predefined safety standards and only allowing an authorized user to access the vehicle.

In an advantageous refinement of the solution according to the invention, provision is made for the external electrical power source to be formed by a mobile identification provider for keyless authentication of the authorized user of the vehicle, and/or for the external electrical power source to be formed by a mobile electrical power storage device, in particular by a USB power bank, and/or for the external electrical power source to be able to be electrically connected to the protective circuit device via one or more power supply connections, in particular via at least one USB connection and/or via at least one terminal connection.

In an emergency, unlocking-related devices of the vehicle involved in keyless authentication of an authorized user of the vehicle can be supplied with electrical power via an electrical power source of a mobile identification provider. The mobile identification provider may, for example, be a smartphone or a transponder key.

If the amount of external electrical power provided by a mobile identification provider is not enough to supply electromechanical components, such as a door actuator unit of the vehicle for the electrical opening of a locking system, with enough electrical power, use can alternatively and/or additionally be made, for example, of a USB power bank as an external electrical power source. The USB power bank can be formed as a USB-C power bank.

The external electrical power source can be electrically connectable to the protective circuit device via one or more power supply connections of the device. Provision can be made for at least one USB connection, in particular a USB-PD connection and/or a USB-C connection, and at least one bipolar terminal connection to be provided. Whilst the bipolar terminal connection has at least two current supply lines, the USB connection forms a communication line and a current supply line, only the communication line of the USB connection being specified below for the sake of clarity, but a communication line and a current supply line of the USB connection always being meant thereby. The USB connection can form a plug, in particular a female plug, into which the communication line and the current supply line of the USB connection flow.

The mobile identification provider, in particular a smartphone or a transponder key, can be connected to a communication line via a USB connection.

A USB power bank can be connected to a communication line via the USB connection.

A USB-C connection is particularly suitable so that the latter can transmit a high current strength as standard whilst at the same time requiring a physically smaller plug.

It is also possible for a plurality of terminals, in particular a plurality of USB-C power banks, to be electrically connected via a USB-C connection so that the authorized user can use their existing electronic terminals for the external electrical power supply.

In order to extend the range of possible connections, a terminal connection can also be provided. This can be used through the connection of a bipolar charger. Examples of such include a jump lead, a car charger or virtually any bipolar connection.

Depending on the accessory available, the authorized user can choose between a USB-C connection or a conventional terminal connection similar to a jump start support point. In order to feed in current, for example, a power bank can be connected to the USB-C connection or a jump lead can be clamped to the terminal connection.

The power supply connections can be arranged in a power supply point of the vehicle.

In an advantageous refinement of the solution according to the invention, provision is made for the protective circuit device to form a high voltage protection arrangement for high voltage protection, and/or for the protective circuit device to form an overvoltage protection arrangement for overvoltage protection, and/or for the protective circuit device to form a residual voltage peak protection arrangement for residual voltage peak protection, and/or for the protective circuit device to form a reverse polarity protection arrangement for reverse polarity protection, and/or for the protective circuit device to be formed so that it transforms the electrical power supplied from the external electrical power source so that unlocking-related devices of the vehicle are supplied with an operating current of 5 A and/or an operating voltage of 15 V.

The high voltage protection arrangement of the protective circuit device can form protection against high voltage above 350 V. The overvoltage protection arrangement of the protective circuit device can form protection against high voltage above 26 V. The residual voltage peak protection arrangement of the protective circuit device can form protection against residual voltage peaks, in particular voltage smoothing. The reverse polarity protection of the protective circuit device can facilitate operation since a user can connect to the positive or negative pole as desired.

The high voltage protection arrangement can be electrically connected to the external electrical power source on the input side and to the overvoltage protection arrangement on the output side. The overvoltage protection arrangement can be electrically connected to the high voltage protection arrangement on the input side and to the residual voltage peak protection arrangement on the output side. The residual voltage peak protection arrangement can be electrically connected to the overvoltage protection arrangement on the input side and to the reverse polarity protection arrangement on the output side. The reverse polarity protection arrangement can be electrically connected to the residual voltage peak protection arrangement on the input side and to the unlocking-related devices of the vehicle on the output side.

If the protective circuit device transforms the electrical power supplied from the external electrical power source so that unlocking-related devices of the vehicle are provided with an operating current of substantially 5 A and/or an operating voltage of substantially 15 V, then the unlocking-related devices of the vehicle can be supplied with precisely the electrical power that they would also receive via the onboard electrical system in the failure-free normal operation of the vehicle.

In an advantageous refinement of the solution according to the invention, provision is made for a door handle device for the mechanical unlocking of the vehicle, in particular of a vehicle door, and/or for detecting an activation of a door by the authorized user of the vehicle to be formed, wherein the door handle device is supplied with electrical power using the protective circuit device in order, after a successful keyless authentication of an authorized user of the vehicle, to carry out a mechanical unlocking of the vehicle, in particular of a vehicle door.

The invention also relates to a vehicle, in particular a rail-free road vehicle, having the device according to the invention for carrying out the method according to the invention. The vehicle can have a power supply point accessible from outside in which power supply connections can be arranged.

In an advantageous refinement of the solution according to the invention, provision is made for the vehicle to form an externally accessible power supply point via which an external electrical power source can be electrically connected to the protective circuit device.

Provision can be made for a cover existing in the vehicle to be used for the power supply point in order for the power supply point to be placed behind it. For example, the installation space in the recess of the towing eye which is accessible via a moveable cover in the front spoiler of the vehicle can be used for this.

Optimal use can thereby be made of the installation space available in the vehicle so that, for example, existing stowage possibilities are reduced.

Further important features and advantages of the invention are set out in the subclaims, in the drawings and in the associated description of the figures by reference to the drawings.

It is self-evident that the features mentioned above and those yet to be explained below can be used not only in the combination specified, but also in other combinations or on their own without leaving the scope of the present invention.

### BRIEF DESCRIPTION OF THE DRAWING FIGURES

Preferred exemplary embodiments of the invention are shown in the drawings and are explained in more detail in the following description, identical reference numerals relating to identical or similar or functionally identical components.

The following is shown in each case schematically:

FIG. 1 shows a perspective view of a vehicle according to the invention,

FIG. 2 shows a perspective view of a power supply point,

FIG. 3 shows a perspective view of a power supply point with a connected electrical external power source,

FIG. 4 shows a circuit diagram comprising a device according to the invention,

FIG. 5 shows a circuit diagram of a protective circuit device.

### DETAILED DESCRIPTION

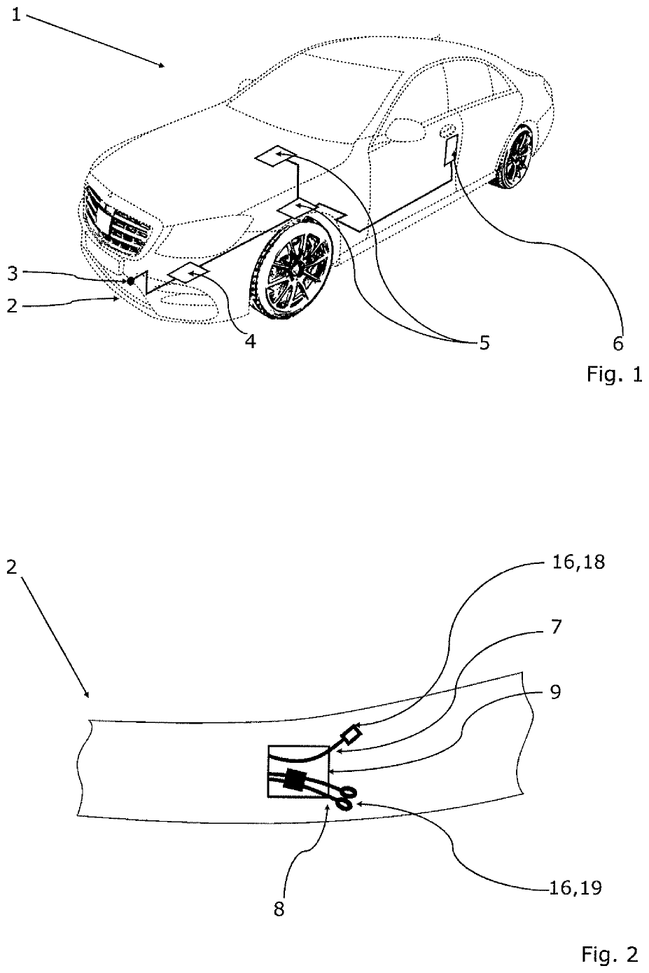

FIG. 1 shows a perspective view of a vehicle 1 according to the invention, having a power supply point 3 formed in a front spoiler 2 of the vehicle 1, via which a protective circuit device 4 can be supplied with electrical power (not shown). The protective circuit device 4 transforms the electrical power supplied from the external electrical power source so that unlocking-related devices 5 of the vehicle 1 can be operated non-destructively. The unlocking-related devices 5 of the vehicle 1 may, for example, drive a door handle device 6 to unlock a locking system of the vehicle 1 if keyless authentication of an authorized user of the vehicle 1 has been successfully carried out. The protective circuit device 4 is arranged inside the vehicle 1 so that no malicious damage can take place.

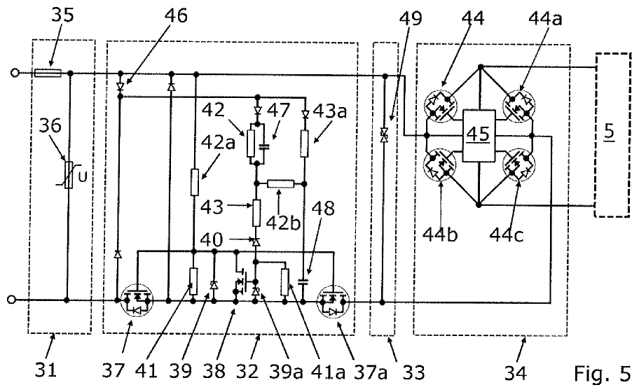

FIG. 2 shows a perspective view of a power supply point 3, wherein the power supply point 3 is formed in the installation space of a recess 9 of a towing eye of the vehicle 1, wherein the installation space is accessible via a movable cover 17 of the front spoiler 2 which is indicated in FIG. 4. A USB connection 18 with a communication line 7 and a bipolar terminal connection 19 with two current supply lines 8 are provided as power supply connections 16 of the power supply point 3.

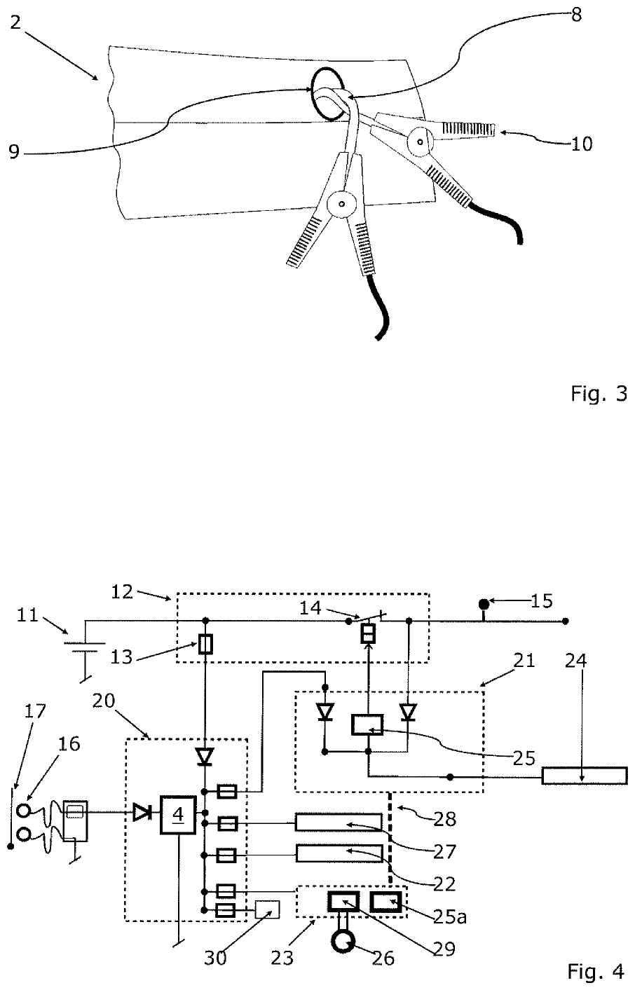

FIG. 3 shows a perspective view of a power supply point 3, wherein, for example, the bipolar terminal connection 19 is electrically conductively connected to external terminals in order to provide an external electrical power supply to the protective circuit device 4.

FIG. 4 shows a circuit diagram comprising a device according to the invention for the external electrical power supply of unlocking-related devices 5 of a vehicle 1 in the event of an error function of an internal electrical power supply of these devices 5 using an internal electrical power source 11 arranged in the vehicle 1. Diodes and fuses are not provided with individual reference numerals and are immediately recognizable to the person skilled in the art.

The unlocking-related devices 5 include, for example, an electrical ignition lock unit 22 for keyless authentication or validation of digital keys, a radio receiver unit 22 for receiving radio signals and/or digital keys, a door control device unit 23 unit for driving an electrical door actuator unit 26 for unlocking a door lock, an electrical door actuator unit 26 that can release a safety catch of the door lock via an electric motor, a signal detection device 24 can be formed for detecting door activation gestures. These units can be connected to one another via an indicated bus system 28 so as to be able to communicate.

The door actuator unit 26, the door control device unit 23, and the signal detection device 24 can be formed through the door handle device 6 in a vehicle door.

It can clearly be seen in FIG. 4 that the unlocking-related devices 5 are not supplied with electrical power if the internal electrical power source 11 of the vehicle 1 has an error function or if the supply of electrical power is interrupted for other reasons.

In such a case, the protective circuit device 4 can be supplied with external electrical power via the power supply connections 16 via an external electrical power source (not shown), in particular via a USB power bank and/or a smartphone and/or a transponder key.

The electrical ignition lock unit 22 can comprise a control device 25, in particular a microcontroller. The electrical ignition lock unit 22 can also drive a battery disconnection switch 14, which is arranged in a fuse box 12 of the internal electrical power source 11. The fuse box 12 also comprises a battery fuse 13. A door control device unit 23 can comprise a control device 25a, in particular a microcontroller. The door control device unit 23 can also comprise a power electronics module 29, in particular an H-bridge circuit. The circuit in FIG. 4 also comprises a connection 15 to a flexible service system.

The protective circuit device 4 can be arranged in a distributor circuit arrangement 20, wherein the distributor circuit arrangement 20 forms an electrical supply between the protective circuit device 4 and the unlocking-related devices 5. A fuse can be provided between each unlocking-related device 5 and the protective circuit device 4. It is also possible, for example, for further consumers 30 and/or a Bluetooth® module 27 to be electrically connected to the distributor circuit arrangement 20.

The device according to the invention and/or the vehicle 1 according to the invention can comprise all of the components shown in FIG. 4.

FIG. 5 shows a circuit diagram of a protective circuit device 4.

A high voltage protection arrangement 31 is electrically connected to an external electrical power source (not shown) on the input side and to the overvoltage protection arrangement 32 on the output side. The overvoltage protection arrangement 32 is electrically connected to the high voltage protection arrangement 31 on the input side and to the residual voltage peak protection arrangement 33 on the output side. The residual voltage peak protection arrangement 33 is electrically connected to the overvoltage protection arrangement 32 on the input side and to the reverse polarity protection arrangement 34 on the output side. The reverse polarity protection arrangement 34 is electrically connected to the residual voltage peak protection arrangement 33 on the input side and to the unlocking-related devices 5 of the vehicle 1 on the output side.

The high voltage protection arrangement 31 comprises a fuse 35 and a varistor 36. The fuse 35 can be formed as an “Si, 5 A flink” with high DC breaking capacity. The varistor 36 may, for example, be a B72220X2271K501 varistor.

The overvoltage protection arrangement 32 comprises two power FETs 37 and 37a which can be formed as IPB60R099CPA FETs. The overvoltage protection arrangement 32 comprises an FET 38, which can be formed as a BS170 FET or BSS316N FET. The overvoltage protection arrangement 32 comprises two 12V Zener diodes 39 and 39a that can have a breakdown voltage of 12 V. The overvoltage protection arrangement 32 comprises a 20V Zener diode 40, which can have a breakdown voltage of 20 V. The overvoltage protection arrangement 32 comprises two 1M resistors 41 and 41a, each of which have an electrical resistance of 1 MΩ. The overvoltage protection arrangement 32 comprises two 390k resistors 42 and 42a, each of which have an electrical resistance of 390 kΩ. The overvoltage protection arrangement 32 comprises two 1 k resistors 43 and 43a, each of which have an electrical resistance of 1 kΩ. The overvoltage protection arrangement 32 comprises a plurality of diodes 46, which can be formed as 1N4007 diodes. The overvoltage protection arrangement 32 comprises a 1 nF/400V capacitor 47 with 1 nF and a 10 nF/400V capacitor 48 with 10 nF.

The residual voltage peak protection arrangement 33 comprises a suppressor diode 49, which can be formed as a SM8 A27 suppressor diode.

The reverse polarity protection arrangement 34 comprises four FET bridges 44, 44a, 44b and 44c (for example IPB80N06S2-07) and a bridge control device 45 (for example LT4320).

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for externally suppling electrical power to unlocking-related devices of a vehicle in the event of an error function of an internal electrical power supply by an internal electrical power source arranged in the vehicle for the unlocking-related devices to provide keyless authentication of an authorized user of the vehicle, the method comprising:
supplying electrical power to a protective device via an external electrical power source; and
transforming, by the protective circuit device, the electrical power supplied from the external electrical power source so that unlocking-related devices of the vehicle can be operated non-destructively,
wherein the protective circuit device supplies the electrical power exclusively to unlocking-related devices of the vehicle involved in the keyless authentication of the authorized user of the vehicle to reduce the amount of external electrical power required,
wherein, after the unlocking-related devices of the vehicle involved in the keyless authentication have been supplied with the electrical power, the keyless authentication of the authorized user of the vehicle is provided by the unlocking-related devices of the vehicle,
wherein the keyless authentication of the authorized user of the vehicle is performed using a mobile identification provider in an external power supply of the unlocking-related devices through the external electrical power source in a same way as keyless authentication of the authorized user of the vehicle in an internal power supply of the unlocking-related devices using an internal electrical power source arranged in the vehicle,
wherein the external electrical power source is provided by the mobile identification provider for the keyless authentication of the authorized user of the vehicle or the external electrical power source is provided by a USB power bank, and
wherein the external electrical power source is electrically connected to the protective circuit device via at least one USB connection or via at least one terminal connection.

10. The method of claim 9, wherein the protective circuit device provides high voltage protection,
provides overvoltage protection,
provides residual voltage peak protection,
provides reverse polarity protection, or
transforms the electrical power supplied from the external electrical power source so that unlocking-related devices of the vehicle are provided with an operating current of 5 A or an operating voltage of 15 V.

11. The method of claim 9, wherein if an activation of a door by the authorized user of the vehicle is detected by a door handle device of a door of the vehicle or if the external electrical power source is formed as a USB power bank and provides a sufficient amount of electrical power to carry out a mechanical unlocking of the vehicle, the method further comprises:
mechanically unlocking the door of the vehicle after a successful keyless authentication of the authorized user of the vehicle.

12. A device that supplies external electrical power supply to unlocking-related devices of a vehicle in the event of an error function of an internal electrical power supply of the unlocking-related devices using an internal electrical power source arranged in the vehicle to provide keyless authentication of an authorized user of the vehicle, the device comprising:
a protective circuit device configured to be supplied with electrical power via an external electrical power source, wherein the protective circuit device is configured to transform the electrical power supplied from the external electrical power source so that unlocking-related devices of the vehicle can be operated non-destructively,
wherein the protective circuit device is electrically conductively connected to unlocking-related devices of the vehicle and is arranged to exclusively supply the unlocking-related devices of the vehicle with electrical power to reduce the amount of external electrical power required,
wherein the unlocking-related devices of the vehicle are configured for the keyless authentication of an authorized user of the vehicle,
wherein the external electrical power source is a mobile identification provider for the keyless authentication of the authorized user of the vehicle or the external electrical power source is formed by a USB power bank, and
wherein the external electrical power source is electrically connectable to the protective circuit device via at least one USB connection or via at least one terminal connection.

13. The device of claim 12, wherein the protective device is configured
as a high voltage protection arrangement for high voltage protection,
as an overvoltage protection arrangement for overvoltage protection,
as a residual voltage peak protection arrangement for residual voltage peak protection,
as a reverse polarity protection arrangement for reverse polarity protection, or
to transform the electrical power supplied from the external electrical power source so that unlocking-related devices of the vehicle are supplied with an operating current of 5 A or an operating voltage of 15 V.

14. The device of claim 12, wherein a door handle device for the mechanical unlocking of a door of the vehicle, or for detecting an activation of a door by the authorized user of the vehicle is supplied with electrical power using the protective circuit device in order, after a successful keyless authentication of the authorized user of the vehicle, to carry out a mechanical unlocking of the door of the vehicle.

15. A rail-free road vehicle, comprising:
a vehicle door;
unlocking-related devices configured to unlock the vehicle door responsive to keyless authentication of an authorized user of the vehicle; and
a protective circuit device configured to be supplied with electrical power via an external electrical power source, wherein the protective circuit device is configured to transform the electrical power supplied from the external electrical power source so that unlocking-related devices of the vehicle can be operated non-destructively,
wherein the protective circuit device is electrically conductively connected to unlocking-related devices of the vehicle and is arranged to exclusively supply the unlocking-related devices of the vehicle with electrical power to reduce the amount of external electrical power required,
wherein the unlocking-related devices of the vehicle are configured for the keyless authentication of the authorized user of the vehicle,
wherein the external electrical power source is a mobile identification provider for the keyless authentication of the authorized user of the vehicle or the external electrical power source is formed by a USB power bank, and
wherein the external electrical power source is electrically connectable to the protective circuit device via at least one USB connection or via at least one terminal connection.

16. The vehicle of claim 15, wherein the vehicle forms an externally accessible power supply point via which the external electrical power source is electrically connectable to the protective circuit device.
